(19) United States
(12) Patent Application Publication
(10) Pub. No.: US 2009/0095771 A1
(43) Pub. Date: Apr. 16, 2009

(54) Beverage base dispenser and method

(76) Inventor: George H. Hoover, Carmel, CA (US)

Correspondence Address: PYLE & PIONTEK LLC, 221 N. LASALLE STREET, SUITE 1207, CHICAGO, IL, 60601, US

(21) Appl. No.: 12/287,911

(22) Filed: Oct. 15, 2008

Related U.S. Application Data
(60) Provisional application No. 60/998,940, filed on Oct. 15, 2007.

(51) Int. Cl. B67D 5/56; G01F 11/00

(52) U.S. Cl. 222/129.1; 222/1

(57) ABSTRACT

A fountain beverage dispensing system is characterized by delivering a beverage base and a diluent for the beverage base to a dispense nozzle, adding one or more of flavors, colors and s additives to the beverage base and diluent to provide a fountain beverage, and delivering the fountain beverage into a cup for service to a customer.

This application claims benefit of provisional application Ser. No. 60/998,940, filed Oct. 15, 2007.

### FIELD OF THE INVENTION

The present invention relates generally to beverage dispensing systems, and in particular to a fountain beverage dispensing system and method for dispensing a fountain beverage.

### BACKGROUND OF THE INVENTION

Fountain beverage dispensers typically use post-mix beverage dispensing valves to provide for the mixing of beverage syrup with a diluent such as carbonated or non-carbonated water. Many such valves dispense only one brand or flavor at a time, although beverage dispensing valves that can be operated to dispense one of a plurality of beverages out of a single dispensing nozzle are known. These multiple flavor dispensing valves increase the number of different drink brands that can be dispensed from a beverage dispenser of a given size or footprint However, conventional multiple flavor post-mix beverage dispensing valves generally do not perform as well as individual dedicated valves, particularly with respect to dispensing a drink that has a high level of carbonation.

Certain drinks can be modified by the addition of a staple flavoring such as cherry, vanilla, lemon or lime. These flavorings can be added to the basic syrup formulation as provided to a user, but that undesirably adds significantly to the number of beverage dispensing valves required due to the need to dispense an increased number of differently flavored and otherwise branded drinks, especially where the valves are of the dedicated single flavor variety type. Multiple flavor valves can be used, but such conventional valves do not necessarily fully alleviate the problem, particularly when further variations of the basic drink flavor are required, such as caffeinated or non-caffeinated.

A disadvantage of prior fountain beverage systems is that they offer far fewer beverage options to consumers than do chilled bottle/can coolers. In many stores, particularly convenience stores, bottle/can choices may and often do far outnumber fountain beverage choices by 10 to 1 or more. Consequently, the industry has moved to add additional flavors with fountain beverage dispensers by adding more dispensing valves and even utilizing multi-flavor valves. However, a major obstacle is that each different flavor requires its own syrup supply, syrup pump, tubing, etc., which syrup, when mixed with a diluent, constitutes a single branded beverage. Given that existing normally offered flavors account for a majority of purchases, it is difficult to justify the investment needed to add the capability to serve additional flavors of beverages. Additionally, each flavor added requires additional space for the container in which it is supplied, and available space for flavor containers is often limited. Further, although the additional flavors may be desired by a substantial number of customers, they are often in the minority as compared with those customers who order more conventional flavors, with the result that the additional flavor containers may not be depleted before their expiration date, requiring their disposal.

One way syrup companies have addressed this situation is by offering flavorings to their existing products. For example, cherry, lemon or lime flavoring may be added to a cola at the nozzle to expand the number of flavor choices available to customers. These flavors are normally concentrated, so they normally do not need to be chilled before addition to the beverage and they can be stored at or near the beverage dispenser instead of in a back room or syrup storage area. However, since flavors have generally been added into beverages at and by the same beverage dispenser from which the primary beverage is obtained, from a consumer perspective everything comes from the same utilitarian box. This makes it difficult to create distinct product images and price different products at different levels.

A major limitation of the existing approach to providing different favors of beverages is that it basically “doctors” an existing soft drink. It does not allow one to choose a specific and known type of beverage, nor does it allow tracking of the addition of shots of, for example, energy additives or the like. It basically adds a flavoring over and to the basic beverage syrup.

### OBJECT OF THE INVENTION

A primary object of the present invention is to provide a beverage dispenser for, and a method of constituting a fountain beverage by adding diluent, flavors and colors to a generic beverage base.

### SUMMARY OF THE INVENTION

In accordance with the present invention, a fountain beverage dispensing and control system comprises a beverage dispenser having a dispense nozzle; means for delivering beverage base to the beverage dispenser; means for delivering diluent for the beverage base to the beverage dispenser; means for delivering flavors to the beverage dispenser; means for delivering colors to the beverage dispenser; and means for operating the beverage dispenser to dispense beverage base and diluent from the dispense nozzle and, optionally, to dispense at least one of flavor and color.

In a preferred embodiment, the system includes a chiller through which the means for delivering beverage base and the means for delivering diluent flow the beverage base and diluent prior to delivery of the same to the beverage dispenser, and included are for delivering additives to the beverage dispenser, such that the means for operating the beverage dispenser operates the same to dispense beverage base and diluent from the dispense nozzle and, optionally, at least one of flavor, color and additive.

The system may also advantageously include a point of purchase device for receiving inputs representative of a specific beverage to be dispensed by the beverage dispenser and for controlling the beverage dispenser to dispense from the dispense nozzle beverage base and diluent and, optionally, one or more of flavors and colors, that together constitute the specific beverage. The system can further include a customer input panel for receiving manual inputs by a customer representative of a specific beverage to be dispensed by the beverage dispenser for the customer and for controlling the beverage dispenser to dispense from the dispense nozzle beverage base and diluent and, optionally, one or more of flavors and colors, that together constitute the specific beverage. The system may further have a payment center for receiving payment by the customer and coupled to the customer input panel for controlling the same, such that the beverage dispenser dispenses the specific beverage only after the payment center has received payment by the customer. Further, the system may include a label generator for generating a label identifying the beverage dispensed by the beverage dispenser.

The invention also contemplates a method of dispensing a fountain beverage with a beverage dispenser having a dispense nozzle, comprising the steps of delivering beverage base to the beverage dispenser; delivering diluent for the beverage base to the beverage dispenser; delivering flavors to the beverage dispenser; delivering colors to the beverage dispenser; and operating the beverage dispenser to dispense beverage base and diluent from the dispense nozzle and, optionally, to dispense at least one of flavor and color.

In a preferred practice of the method, the delivering beverage base and delivering diluent steps include delivering beverage base and diluent through a chiller to the beverage dispenser. Included is the step of delivering additives to the beverage dispenser, such that the step of operating the beverage dispenser then operates the same to dispense beverage base and diluent from the dispense nozzle and, optionally, at least one of flavor, color and additive. The method also contemplates the step of inputting to a point of purchase device inputs representative of a specific beverage to be dispensed by the beverage dispenser, the operating step then being responsive to the inputs to control the beverage dispenser to dispense from the dispense nozzle beverage base and diluent and, optionally, one or more of flavors and colors, that together constitute the specific beverage. The method can also include the steps of manually inputting to a customer input panel inputs representative of a specific beverage to be dispensed by the beverage dispenser, such that the operating step is then e to the inputs to control the beverage dispenser to dispense from the dispense nozzle beverage base and diluent and, optionally, one or more of flavors and colors, that together astute the specific beverage; together with receiving payment for the specific beverage at a payment center, and enabling the corner input panel to control the beverage dispenser to dispense the specific beverage in response to payment being received For a customer's convenience and to identify the beverage dispensed, a label identifying the specific beverage dispensed by the beverage dispenser may be generated.

The foregoing and other objects, advantages and features of the invention will become apparent upon a consideration of the following detailed description, when taken in conjunction with the accompanying drawings.

### BRIEF DESCRIPTION OF THE DRAWINGS

FIG. 1 is a schematic representation of a prior art beverage dispensing system: and

FIG. 2 is a schematic representation of a fountain beverage dispensing system embodying the teachings of the present invention.

### DETAILED DESCRIPTION

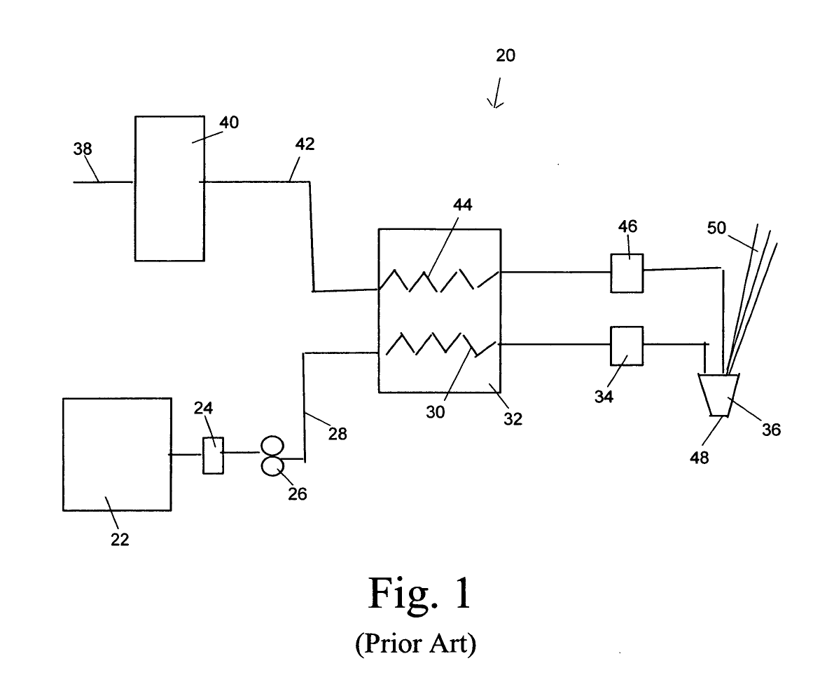

A schematic representation of a conventional fountain beverage dispensing system is shown in FIG. 1 and indicated generally at 20. In such a beverage dispensing system, a supply 22 of concentrate beverage syrup is coupled through a syrup connector 24, a syrup pump 26 and tubing 28 to and through a circuit 30 of a chiller 32, which chiller may be a water bath chiller or a cold plate. The syrup pump 26 propels the syrup through the chiller circuit to chill the syrup to near 32° F., and from the chiller the syrup flows through a syrup flow rate control device 34 to a beverage dispense nozzle 36

A water line 38, which normally would be connected to a city main, delivers water to an inlet to a carbonator 40, within which the water is carbonated in a manner well understood in the art Carbonated water exiting the carbonator 40 flows through tubing 42 to and through at least one circuit 44 of the chiller 32. Upon exiting the chiller, the carbonated water flows to and through a water flow rate control device 46 to the beverage dispense nozzle 36. As is understood, the syrup flow rate controller 34 and water flow rate controller 46 control the flow rates of syrup and water so that a desired selected ratio of water and syrup is delivered to the nozzle 36 for mixing therein and dispensing therefrom as a finished beverage product that exits an outlet 48 from the nozzle for delivery into a cup positioned beneath the nozzle.

In conventional beverage dispensing systems, the beverage syrup supply 22 is product or brand specific. In other words the syrup, when mixed with an appropriate diluent such as plain or carbonated water, constitutes or produces a specific brand of beverage, such for example as is provided in a bottle or can on market shelves. Provision can be made for small quantities of one or more selected flavor additives 50 to be injected into the water and syrup in the dispense nozzle 36, so that a flavored product specific branded beverage can be served to a customer.

A problem with conventional fountain beverage dispensers is that the approach of adding a flavor to beverage specific drink is that it basically “doctors” the drink. It does not allow a customer to vary the basic soft drink served, over and above adding a selected flavor to it.

In improving upon conventional fountain beverage dispensers and methods of dispensing fountain beverages, the invention contemplates dispensing branded beverages that share a common beverage base. Instead of using a beverage syrup that when mixed with diluent yields a product or brand specific beverage, a “generic” beverage base be is used, which beverage base is common to and found in all products in a line of products carrying a common brand, and which has all of the product attributes of the products in the branded line except color and flavor. In other words, the invention is used to dispense beverages that share a common beverage base. An advantage of using a beverage base that is common to a branded product line is that by introducing colors and flavors into a mixture of the beverage base and a diluent, it becomes possible to offer an array of colors and flavors of the branded beverage, similar to what one might expect to find on market shelves, and each beverage can be further customized, if desired, with additional additives. Such additives can comprise, by way of example, caffeine, energy boosters, vitamins, etc. Flavor, color, water and a generic beverage base are blended at the dispenser, with use of the generic beverage base liquid permitting the use of relatively small containers for flavor, color and additives, which decreases storage requirements and makes use of a multi-flavor tower feasible.

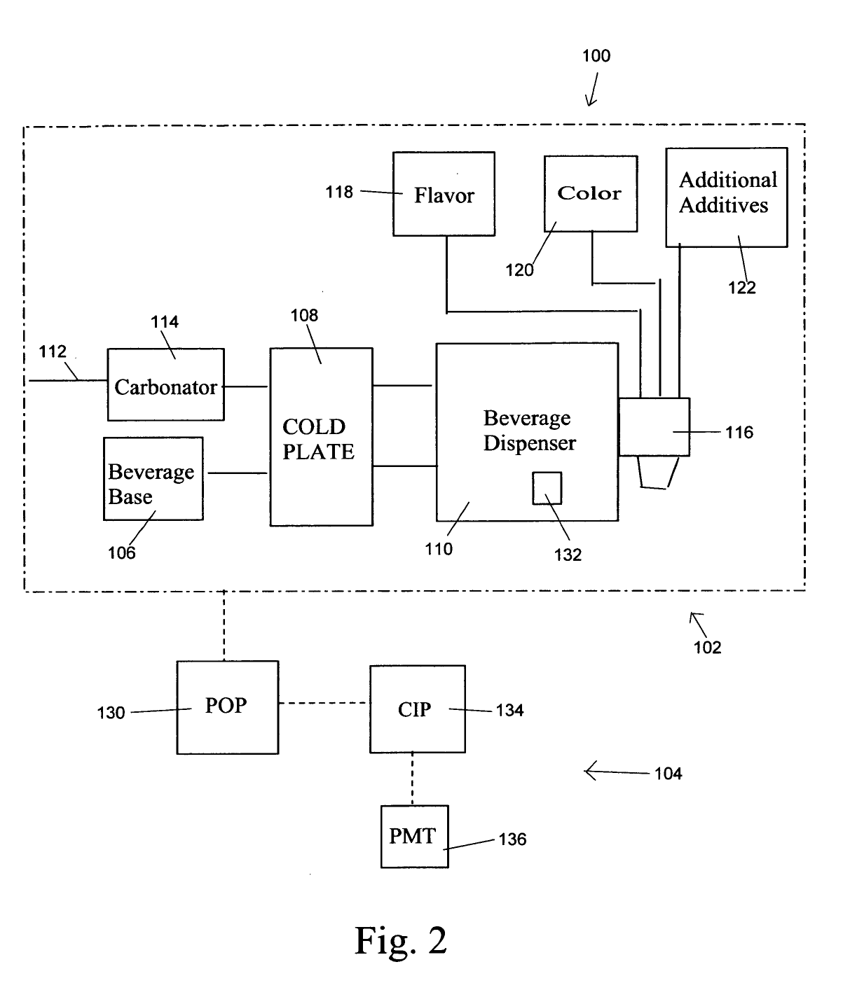

FIG. 2 shows a fountain beverage dispensing and control system, indicated generally at 100, of a type with which the teachings of the invention may advantageously be used. The system 100 generally comprises a fountain beverage dispensing system 102 and a customer input terminal 104. The fountain beverage dispensing system 102 comprises a beverage base supply 106 that includes a pump (not shown) for delivering liquid beverage base through a chiller 108, which chiller may be a refrigerated water bath or a cold plate, and then to a beverage base inlet to a beverage dispenser 110. The beverage dispensing system 102 also comprises a diluent supply, which can be plain or carbonated water, and in the dispenser as shown the diluent supply is a water line 112 for delivering water from a city main to a carbonator 114, within which carbonator the water is carbonated in a manner understood in the art. Carbonated water is delivered through the chiller 108 and then to a diluent inlet to the beverage dispenser 110. The beverage dispenser includes a plurality of dispense nozzles 116 (only one being shown), each coupled to an associated post-mix dispense valve (not shown) for dispensing a selected beverage into a customers cup positioned beneath the nozzle. Also fluid coupled to the dispense nozzle 116 is a supply 118 of a plurality of different flavors that may be added to a beverage being dispensed, a supply 120 of a plurality of different colors that may be added to a beverage being dispensed, and a supply 122 of a plurality of different additional additives that may be added to a beverage being dispensed. While in FIG. 2 the supplies of flavors 118, colors 120 and additives 122 are shown as being fluid coupled directly to the dispense nozzle 116, it is understood that the supplies can be fluid coupled to the dispense nozzle through the chiller 108.

When a beverage selected by a customer is to be dispensed, carbonated water and beverage base from the carbonator 114 and beverage base supply 106 are delivered through the chiller 108 to the beverage dispenser 110 for being dispensed in a selected and controlled diluent/beverage base ratio, with a selected one or more of the flavors from the flavor supply 118, a selected one or more of the colors from the color supply 120, and a selected one or more additional additives from the additives supply 122, optionally being delivered to the dispense nozzle 116 for introduction into the reconstituted beverage base being flowed into a cup held beneath the dispense nozzle. To provide for introduction of flavors, colors and additional additives into the beverage, the dispense nozzle 116 can be of a type as taught by U.S. Pat. No. 7,159,743, issued Jan. 9, 2007, or as taught by U.S. publication No. 2008/0115989 A1, published Jun. 2, 2005, each of which is assigned to IMI Cornelius Inc., the assignee of the present invention and the teachings of each of which are specifically incorporated herein by reference.

To provide for customer selection of a beverage so that the customer may, for example, be served a branded beverage that is the same as that which might be found on market shelves, and also to enable the customer to select any additional additive(s) to be added to the beverage, the invention contemplates that the fountain beverage dispensing and control system 100 include the customer input terminal 104 for controlling the beverage dispensing system 102. In particular, the beverage dispensing system 102 is electronically connected to a point of purchase device (POP) 130 of the input terminal via either a hardwired or wireless connection. When an order is placed by a customer at the point of purchase device 130, it is sent to the beverage dispensing system 102 with an associated identifier, which identifier contains all of the instructions required by the beverage dispensing system to make and dispense the specific complex beverage ordered by the customer. In this manner, the beverage dispensing system can be activated to dispense specific complex beverages ordered by customers with a simple action, such as by pushing a “serve button” (not shown). The identifier can be a number, barcode, token or any number of other identification means, so that the beverage dispenser 110 can be placed behind or at a self-service counter, since the particular beverage to be dispensed is controlled electronically by the point of purchase device 130. If desired, an optional label maker 132 can be provided at the beverage dispenser to provide labels for attachment to cups to identify the specific beverages ordered by customers.

As a variation of the input control for the beverage dispensing system 102, a consumer input panel (CIP) 134 can be provided at the customer input terminal 104 and coupled to the point of purchase device 130 to accommodate customer input of beverage orders. The customer's input at the consumer input panel 134 can go directly to the point of purchase device 130 or, if desired, the output from the consumer input panel 134 can be electronically coupled by hardwire or wireless connection to the beverage dispensing system 102 to control dispensing of the specific beverage ordered by the customer. Optionally, a payment station 136 can be provided so that the customer can pay for the beverage ordered, and once payment is made an identifier can be sent to the beverage dispensing system 102 to control the same to dispense the specific beverage ordered by the customer. As mentioned, the consumer input panel 134 can communicate with the beverage dispensing system 102 either through or independently of the point of purchase device 130.

In the fountain beverage dispensing and control system 100 of the invention, a liquid beverage base is used, not just a sweetener that when reconstituted with an appropriate diluent produces a branded beverage. The beverage base, when mixed with a diluent such as carbonated water, includes everything common to a branded beverage except those items that the customer can select, such as flavor, color and special additives. An advantage is that the customer is able to select a large variety of different beverages of the same brand or type as may be found on the shelves of grocery stores. The beverage dispenser 110 can be a beverage dispensing tower, and since the beverage dispensing system 102 can be controlled at the customer input terminal 104, a beverage order can stored at the tower until the cashier activates it to enable dispensing of the beverage, which can simplify operation of the system. When a beverage is dispensed, an label output by the label maker 132 can be adhered to the cup for identification of the beverage.

If desired, real juice can be added to the soft drink beverage product. Also, the diluent and beverage base can be re-circulated between the supplies thereof and the tower, for example as described in U.S. Pat. No. 7,337,627, issued Mar. 4, 2008 and assigned to the assignee of the present invention, the teachings of which are specifically incorporated herein by reference. By recirculating the beverage base and diluent, the dispensed beverage will be well cooled since the beverage base and diluent together normally comprise on the order of 95+% of the finished beverage. The flavors, colors and additives may also be cooled by being flowed through the chiller, but since these components constitute only a relatively small percentage of the finished beverage product, their chilling is optional.

Since the flavors, colors and additives constitute only a relatively small percentage of the finished beverage, for convenience the supplies of the same may be located near the tower and for sanitation purposes their packaging can include disposable tubing. The use of a beverage base that is generic to a branded product line eliminates the need for separate flavor beverage lines, pumps and bag in box connections leading from a distant storage room to the tower. It also allows for frequent flavor changes and an increased number of different flavors being available for service to customers. If desired, multiple towers can be provided with delivery of beverage components from the same supplies thereof, with at least the beverage base and diluent being cooled by a chiller, thereby to have multiple beverage serving stations.

The beverages to be dispensed are not limited and can be fruit flavored, include real fruit juice and be offered in various colors. The beverage base can be and often is a cola, but it also can be tea, in which case a myriad of sweeteners can be offered, along with flavorings for the tea. The beverage base could also be coffee, such that the tower delivers custom flavors and other additives, as well as milk and cream, and it is contemplated that a sweetened coffee slurry could be delivered at various sweetness levels. Alternatively, the beverage base could be reverse-osmosis water, with various additives for the water being available.

It is to be appreciated that syrup suppliers consider it desirable to make more flavors available for fountain beverages, which presently is done by adding flavors on top of beverages, i.e. cherry, lemon tea, etc. Some suppliers have tried to get around the limitations of adding flavors by selectively combining a mixture of a diluent, a syrup sweetener system (sugar syrup or diet syrup) and a flavor concentrate package. This approach amounts to doctoring a basic beverage.

In contrast, in the beverage base dispensing system of the invention the ingredients of the beverage base, except color and flavor, are included in all of the beverages of a beverage product line, so that individual beverages of the product line can be constituted by appropriate additions to the beverage base of diluent, flavor and color. The resulting beverage is not a doctored beverage, but is the same as the selected one of the beverages of the product line. In other words, the beverage base is not just a generic sweetener, but instead is a base for a family of beverage products.

Advantages of the beverage base system to major beverage suppliers are that it can be limited in roll-out and does not require an immediate conversion of existing systems. For example, a major beverage supplier can choose to do one line of beverage products only, such that a single beverage base would be used for all of the individually distinct beverages in the line, with flavoring an color then being added to constitute distinct individual ones of the beverages. The beverage base is not a generic sweetener base, but instead would be proprietary to an individual beverage supplier, so from a beverage supplier's standpoint food service providers would not be able to use the beverage base system. The beverage base system is adapted for use with the majority of the existing installed equipment base, which equipment would require only limited modifications to the valves to be adapted for use with the beverage base system.

The invention therefore provides fountain beverage dispensing systems and methods of dispensing fountain beverages, which enables beverage companies and retailers the ability to offer more beverage choices to their consumers, while at the same time adding customization features that separate branded beverages form mass market beverages. These customization features can include healthier alternative choices in beverages.

While embodiments of the invention have been described in detail, various modifications and other embodiments thereof may be devised by one skilled in the art without departing from the spirit and scope of the invention, ad defined in the appended claims.

What is claimed is:

1. A fountain beverage dispensing and control system, comprising:
a beverage dispenser having a dispense nozzle;
means for delivering beverage base to the beverage dispenser;
means for delivering diluent for the beverage base to the beverage dispenser;
means for delivering flavors to the beverage dispenser;
means for delivering colors to the beverage dispenser; and
means for operating the beverage dispenser to dispense beverage base and diluent from the dispense nozzle and, optionally, to dispense at least one of flavor and color.

2. A system as in claim 1, including a chiller, wherein the means for delivering beverage base and the means for delivering diluent flow the same to the beverage dispenser through the chiller.

3. A system as in claim 1, including means for delivering additives to the beverage dispenser, the means for operating the beverage dispense operating the same to dispense beverage base and diluent from the dispense nozzle and, optionally, at least one of flavor, color and additive.

4. A system as in claim 1, including a point of purchase device for receiving inputs representative of a specific beverage to be dispensed by the beverage dispenser and for controlling the beverage dispenser to dispense from the dispense nozzle beverage base and diluent and, optionally, one or more of flavors and colors, that together constitute the specific beverage.

5. A system as in claim 1, including a customer input panel for receiving manual inputs by a customer representative of a specific beverage to be dispensed by the beverage dispenser for the customer and for controlling the beverage dispenser to dispense from the dispense nozzle beverage base and diluent and, optionally, one or more of flavors and colors, that together constitute the specific beverage.

6. A system as in claim 5, including a payment center for receiving payment by the customer and coupled to the customer input panel for controlling the same such that the beverage dispenser dispenses the specific beverage only after the payment center has received payment by the customer.

7. A system as in claim 1, including a label generator for generating a label identifying the beverage dispense by the beverage dispenser.

8. A method of dispensing a fountain beverage with a beverage dispense having a dispense nozzle, comprising the steps of:
delivering beverage base to the beverage dispenser;
delivering diluent for the beverage base to the beverage dispenser;
delivering flavors to the beverage dispenser;
delivering colors to the beverage dispenser; and
operating the beverage dispenser to dispense beverage base and diluent from the dispense nozzle and, optionally, to dispense at least one of flavor and color.

9. A method as in claim 8, wherein the delivering beverage base and delivering diluent steps include delivering beverage base and diluent through a chiller to the beverage dispenser.

10. A method as in claim 8, including the step of delivering additives to the beverage dispenser, the step of operating the beverage dispenser operating the same to dispense beverage base and diluent from the dispense nozzle and, optionally, at least one of flavor, color and additive.

11. A method as in claim 8, including the step of inputting to a point of purchase device inputs representative of a specific beverage to be dispensed by the beverage dispenser, the operating step being responsive to the inputs to control the beverage dispenser to dispense from the dispense nozzle beverage base and diluent and, optionally, one or more of flavors and colors, that together constitute the specific beverage.

12. A method as in claim 8, including manually inputting to a customer input panel inputs representative of a specific beverage to be dispensed by the beverage dispenser, the operating step being responsive to the inputs to control the beverage dispenser to dispense from the dispense nozzle beverage base and diluent and, optionally, one or more of flavors and colors, that together constitute the specific beverage.

13. A method as in claim 12, including the steps of receiving payment for the specific beverage at a payment center, and enabling the customer input pan to control the beverage dispenser to dispense the specific beverage in response to payment being received.

14. A system as in claim 8, including the step of generating a lab identifying the specific beverage dispensed by the beverage dispenser.
